(19) United States
(12) Patent Application Publication
(10) Pub. No.: US 2014/0038017 A1
(43) Pub. Date: Feb. 6, 2014

(54) ARRANGEMENT COMPRISING AT LEAST ONE ELECTROCHEMICAL CELL, BATTERY COMPRISING A HOUSING, AND A MOTOR VEHICLE COMPRISING A CORRESPONDING BATTERY

(71) Applicants: Stefan Wickert, Albershausen (DE); Prashant Sharma, Stuttgart (DE)

(72) Inventors: Stefan Wickert, Albershausen (DE); Prashant Sharma, Stuttgart (DE)

(21) Appl. No.: 13/985,824

(22) PCT Filed: Feb. 16, 2012
(86) PCT No.: PCT/EP12/52673

§ 371 Date: Oct. 23, 2013

(30) Foreign Application Priority Data
Feb. 17, 2011 (DE) 10-2011-004-282.2

(51) Int. Cl. H01M 2/10

(52) U.S. Cl. CPC H01M 2/1072
USPC 429/99; 429/96

(57) ABSTRACT

An arrangement includes at least one electrochemical cell, a housing, and a closure device. The housing is configured to contain the at least one electrochemical cell. The arrangement is configured such that removal or unregistered removal of one or more of the at least one electrochemical cell from the housing is prevented when the closure device is locked.

The present invention relates to an arrangement comprising at least one electrochemical cell, a battery comprising a housing, and a motor vehicle comprising a corresponding battery, which arrangement can be used in particular to prevent removal, in particular unauthorized removal, of electrochemical cells of the battery or at least to register said removal.

### PRIOR ART

The battery is one of the most important and most expensive parts of an electric or hybrid vehicle. For this reason, most original equipment manufacturers (OEM) require that suppliers of battery packs issue a warranty for their batteries. Also, in addition to the OEM-requirements, guaranties of this type are demanded for example by the legislation relating to zero emission vehicles (ZEV). The period of time for which the warrantee is required is normally between five and ten years. Costs are a further important aspect. Battery packs cost several thousand Euros and if they are to be returned by the OEM to the supplier it is extremely expensive to replace a used battery with a new battery.

Since this warrantee period and the costs for batteries are not comparable with those for other vehicle parts, it is important for the suppliers of the batteries to ensure by means of special measures that the battery was not handled (improperly) by an unauthorized person.

Improper handling can refer for example:
to incorrectly charging/discharging the battery and/or
to replacing a proper-functioning battery by a defective or old battery.

It is possible in accordance with the prior art to recognize that the battery was improperly handled as a result of being incorrectly charged/discharged, in that a battery data recording device is used that indicates the current being supplied to the battery and/or being drawn off from the battery during the charging and/or discharging procedure and said battery data recording device stores the charged state in a storage medium, for example in an electrically erasable programmable read-only memory (EEPROM) or a flash EEPROM. These recordings can be evaluated at a later point in time outside the battery (off board) for analysis purposes or to check the validity of the warranty claims.

A method for identifying a machine tool is known from the publication DE 10 2007 007 506 A1. In order to demonstrate whether a damaged tool is an OEM part, this publication proposes that the housing of the machine tool is produced at least in part from a synthetic material to which an indicator component is added in order to identify the machine tool.

A solution has hitherto not been found to prevent a proper-functioning battery being replaced by a defective and/or an old battery or at least to register that the battery was handled.

### DISCLOSURE OF THE INVENTION

A particular advantage of the invention resides in the fact that unauthorized persons cannot remove a battery and/or an electrochemical cell from a battery pack and cannot for example replace said battery or electrochemical cell by a different battery and/or a different electrochemical cell. This is achieved in that an arrangement is provided in accordance with the invention, which arrangement comprises at least one electrochemical cell and a housing that comprises the at least one electrochemical cell. The housing further comprises a lock, and the arrangement, preferably the housing, is embodied in such a manner that in the case of an activated lock it is not possible to access the at least one electrochemical cell that is located in the housing. In particular, it is not possible in the case of an activated lock to remove the at least one electrochemical cell or even only a single electrochemical cell from the housing. The housing together with the at least one electrochemical cell is preferably embodied as a battery pack.

An alternative embodiment of the invention provides that in the case of an activated lock it is in fact possible to access the at least one electrochemical cell and possible to remove one or several electrochemical cells from the housing. This type of access can be achieved for example in that a lock is used that, even though it is locked, said lock if necessary can be opened by expending a great deal of force. In a preferred embodiment of the invention, a magnetic preferably electromagnetic lock is provided. The locking force of the magnet can be of such a magnitude that the lock can be opened (without authorization) by overcoming this predefined force. In a different preferred embodiment it is provided that the housing comprises a predetermined breaking point that breaks and renders possible access to the at least one electrochemical cell without the lock being unlocked. The broken predetermined breaking point is used to register the fact that the housing was opened and that it was possible to remove electrochemical cells. It is similarly provided in a preferred embodiment that it is registered at least that the non-activated lock was opened, but preferably it is also (likewise) registered that the housing was opened in the case of an activated lock. Since in accordance with the invention it is not possible to remove electrochemical cells in the case of an activated lock at least without it being registered that the housing was opened, as a result of registering that the housing was opened it is consequently registered that there is at least the possibility that one or several electrochemical cells was/were removed.

In a preferred embodiment of the method in accordance with the invention, it is provided that it is recorded in a non-erasable storage means at least once that the battery pack was opened by unauthorized persons; however, it is preferred that a recording is made each time the housing is opened. It has proved to be advantageous for this purpose if at least details regarding the date, the time that the housing was opened, the mileage at the point in time when the housing was opened, identification of a person opening the battery pack or the like are ascertained and recorded. This has the advantage that the circumstances that are of importance for the purpose of assessing the warranty claims can be evaluated more closely with the aid of this information. A preferred embodiment of the invention provides that a FIFO storage device is used as a storage medium. Optimum utilization of the storage is consequently achieved since only one storage place of a predefined size is used, in that as a new entry is stored, older entries are “moved out” of the storage device if the storage device is full. It is preferred that the details are at least detected and/or recorded automatically.

It is provided in a preferred embodiment that it is only possible to unlock the lock once authentication has been established. This has in particular the advantage that as a result it can be established whether the housing was opened by an authorized person. Due to the fact that the above mentioned information is recorded, it is further possible (at a later stage) to evaluate additional details regarding the opening of the housing, said details can be for example when and by whom the housing was opened. It is consequently possible to check whether warranty claims exist or not. A preferred embodiment provides for this purpose that the arrangement comprises data entry means for entering data for authentication purposes, for example an identification code or the like, and an evaluating unit for evaluating the data that has been entered. The lock is preferably automatically unlocked depending upon the result of the evaluation. In a further preferred embodiment, the arrangement comprises further means for outputting data, for example a display, a loud speaker or the like, by means of which for example the result of the evaluation is conveyed to a user. It is preferred that the means for entering data and outputting data and the means for evaluating data are embodied in such a manner that the authentication procedure can be conducted in the form of a dialogue. This is in particular advantageous due to the fact that when performing an authentication procedure of this type in dialogue form it is possible to achieve a higher level of security prior to an unauthorized opening of the housing, in that any user who wishes to open the housing is required to provide information regarding the time, his personal details and/or situation. It is preferred that for identification purposes during the dialogue, at least in part, commands of a unified diagnostic service (UDS) are exchanged between the evaluating unit and the person wishing to open the lock.

It has been demonstrated as being advantageous if the arrangement, preferably the housing or the battery pack, comprises a battery control unit (BCU), wherein the battery control unit is embodied in such a manner that the battery control unit performs at least the authentication procedure and/or the battery control unit monitors any incident of the housing being opened. This is advantageous due to the fact that battery packs generally already comprise a battery control unit and consequently when implementing the invention it is possible to use software and hardware that is already available and it is thus possible to reduce material costs and development costs.

It has been demonstrated as being advantageous if the BCU comprises a hardware switch interlock, for example a high voltage interlock loop (HVIL), and the monitoring procedure includes evaluating the signals that are provided by the hardware switch interlock. However, it can also be demonstrated as advantageous if the monitoring procedure is performed independently of the BCU. Hardware and/or software components can be provided for the monitoring procedure.

In a further preferred embodiment, phases are provided in which the battery control unit is in the idle mode in order to minimize energy consumption. However, the monitoring procedure also remains active while the battery control unit is in the idle mode. In particular, the HVIL also remains active during phases where the BCU is in the idle mode.

In a further preferred embodiment, it is provided that the housing can also be opened without prior authentication. This is particularly of advantage in hazardous situations. It is provided in a preferred embodiment that in predefined cases the locking arrangement is released (automatically) by the BCU so that the battery pack can be opened without being damaged.

A further aspect of the invention relates to a battery having a housing, wherein the battery comprises at least one electrochemical cell and wherein the housing comprises a lock and is embodied in such a manner that in the case of an activated lock it is not possible to remove one or several of the electrochemical cells from the housing nor is it possible to remove said cell(s) from the housing without the incident being registered. It is preferred that the battery is a lithium ion battery or the battery comprises electrochemical cells that are embodied as lithium ion battery cells.

Another aspect of the invention relates to a vehicle having an electric drive motor for the purpose of driving the motor vehicle and further relates to a battery that is connected or can be connected to the electric drive motor in accordance with the inventive aspect that is described in the previous paragraph. However, the battery is not limited to areas of application of this type; on the contrary it can also be used in other electrical systems.

The invention proposes a method that ensures that any battery packs that have been returned by an OEM (following a malfunction report) to the suppliers have in fact not be mishandled by a repair workshop, fuel station or other unauthorized places or persons.

The invention has in particular the advantage that:
In contrast to the prior art it is possible for the BCU to ascertain whether the battery pack was opened by an authorized person or not. It is possible by recording the facts to check the warranty claims of an OEM.
The invention further ensures that the battery pack cannot be opened by an unauthorized person.

Advantageous embodiments of the invention are specified in the subordinate claims and described in the description.

### DRAWINGS

Exemplary embodiments of the invention are further explained with reference to the drawings and the following description, in which:

FIG. 1 illustrates a dialogue of an exemplary authorization query, and

FIG. 2 illustrates an exemplary storage device management procedure for storing information that records that the housing was opened.

### EMBODIMENTS OF THE INVENTION

The invention is described hereinunder with reference to two exemplary embodiments. An important aspect resides in the fact that a battery pack is equipped with a lock mechanism. In addition, it is provided in a further embodiment to equip the battery pack with a monitoring mechanism. The lock mechanism and the monitoring mechanism can be provided in each case alone or together in combination. A preferred embodiment provides that the scope of the functions of the BCU is used in order to control the monitoring mechanism and/or the lock mechanism.

### Lock Mechanism

In order to prevent an unauthorized opening of the battery pack, a lock is provided for the battery pack in a first exemplary embodiment. The lock prevents the battery from being opened without sufficient authentication. The lock is controlled and monitored by the BCU 102 in an exemplary embodiment. It follows from this that the lock can only be opened by authorized persons, for example an authorized inspector 104.

In order to open the lock, the relevant person transmits a sequence of commands, for example commands of a unified diagnostic service, to the BCU 102. The BCU 102 uses these commands to decide whether the person has authorization and in dependence upon this decision said BCU allows access and releases the lock of the battery pack. It is preferred that a magnetic lock is used, in particular it is preferred that an electromagnetic lock is used.

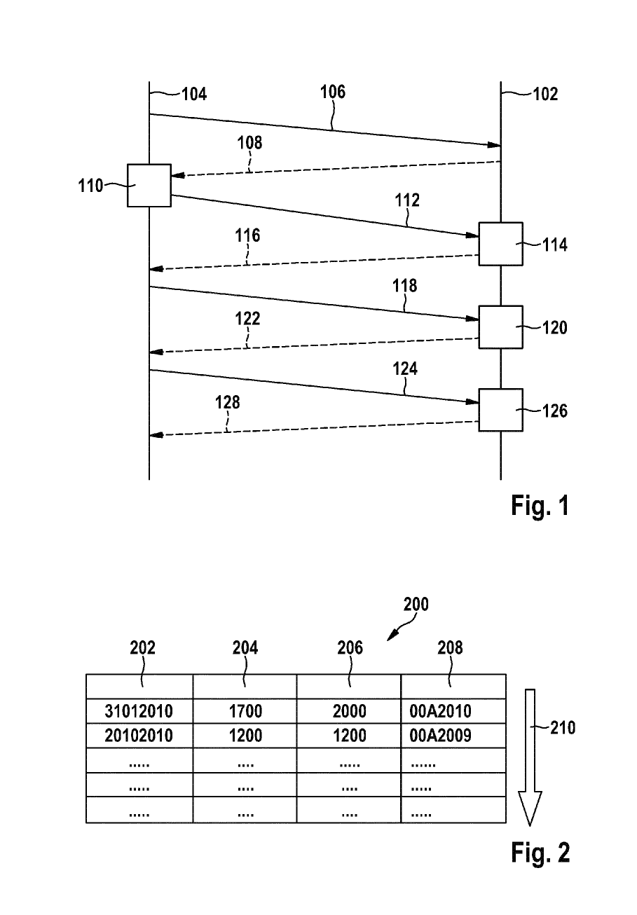

An exemplary sequence of commands is described with reference to FIG. 1:

The inspector 104 transmits the UDS command 106 “security access—request seed” to the BCU 102.

The BCU 102 responds by transmitting 108 a seed.

The inspector 104 uses this seed and in step 110 calculates a key using a security algorithm. The key generated in this manner is transmitted to the UDS command 112 “security access—send key” to the BCU 102.

The BCU 102 uses the same seed and authenticates the key in step 114. The BCU 102 generates for this purpose the verification key using an algorithm inside the storage device. Subsequently, the BCU 102 compares the key that is received by the inspector 104 with the verification key. If the two keys match, the BCU 102 transmits a message 116 to the inspector 104 issuing the authorization for further commands to be entered. In the case of a failed authentication procedure, the message 116 that the BCU 102 transmits after the authentication procedure can also contain a report that access is denied.

The inspector 104 transmits different information 118 that identifies him to the BCU 102, for example an inspector identification code 208, an inspector type or the like. The BCU 102 stores this information 118 in a non-erasable storage device in step 120.

The BCU 102 signals to the inspector 104 by transmitting a message 122 that the information 118 has been successfully stored.

The inspector 104 subsequently transmits the UDS command 124 to the BCU 102 for the purpose of opening the battery pack in order to open the magnetic lock, in that said inspector transmits the UDS command 124 “Routine Control”.

Following receipt of this UDS command 124, the BCU 102 releases the magnetic lock in step 126 and signals this to the inspector 104 by transmitting a message 128.

A similar command sequence can be used in order to lock the magnetic lock.

For security reasons, it is provided in an exemplary embodiment that the BCU 102 opens the lock without having been requested to do so by the inspector 104 if the BCU 102 establishes a hazardous situation. In a further exemplary embodiment it is further provided that the magnetic lock can also be opened without authorization, for example by applying mechanical force. This is achieved in the case of a magnetic lock by correspondingly selecting the magnetic force. A lock that is to be opened in such a forceful manner would publicize an unauthorized opening without at any rate preventing the lock from being opened, which is particularly important for hazardous situations. It is provided in a preferred embodiment that information regarding an unauthorized opening of this type is stored.

It is ensured by using the invention that the battery pack cannot be opened without proven authorization. In addition, the BCU 102 indicates whether the battery pack was opened and stores information regarding time, date and/or mileage in cases where the battery pack was opened. Furthermore, information is stored regarding persons who are authorized to open the battery pack. It is possible using this procedure to evaluate the warranty claims of an OEM.

Lock mechanism and monitoring mechanism: When using the monitoring device, the battery pack is not only locked but rather in an exemplary embodiment in addition (or alternatively) any incident of the battery pack being opened is monitored by the BCU. This is achieved for example by virtue of the fact that an already provided hardware switch interlock of the battery management system (BMS) is used. It is possible to use for example a high voltage interlock lock (HVIL) as a hardware switch interlock of this type. In order to prevent persons coming into contact with lines that are connected to the high voltage, it is possible using a hardware switch interlock to establish that single contacts are not connected. This hardware switch interlock comprises a pulse width modulation (PWM) signal generator of the BMS that influences a series of loop contacts with its signals. If the high voltage connection is not connected, the chain is interrupted. An interrupted chain of this type is recognized by the hardware switch interlock of the BMS, which in this case no longer receives a PWM signal. In this case, the BMS immediately separates all contacts. Furthermore, all other active components that are able to supply high voltage to the bus are likewise prevented from supplying high voltage to the bus. Consequently, the hardware switch interlock ensures that the battery pack cannot be opened without the BCU being informed that the battery pack was opened. In order to avoid that the BCU software is continuously active, it is possible to provide an idle mode for the BCU whilst the ignition is in the switched-off state. The BCU software can be re-enabled in response to a HVIL event. An idle mode of this type has an energy-saving effect.

This mechanism enables the BCU to establish and record each incident when the battery pack is opened. The BCU monitors the signals of the hardware switch interlock (HVIL signals) and thus receives a pulse signal if the battery pack is opened. Following receipt of the pulse signal, the BCU stores the data that describes the incident, for example the date 202, the time 204, the mileage 206, an inspector identification code 208 or the like in a non-erasable storage device. It is preferred that these data cannot be erased, not even by an OEM inspector 104.

In the exemplary embodiment, it is ensured by means of the BCU that each incident “open battery pack” is detected and the corresponding data are stored in the non-erasable storage device. In order to achieve optimum utilization of the storage, the BCU provides a FIFO storage device 200 of a predefined length. As new entries are stored in the FIFO storage device 200, the entries already in storage are pushed onwards, as is illustrated in FIG. 2 by the reference numeral 210.

If the FIFO storage device 200 is full, the older entries are deleted (cf. FIG. 2).

If an OEM sends a defective battery pack to the supplier, the supplier is able to check whether the battery pack was opened by anyone or not. In the event that the battery pack was opened, the date 202 and the time 204 the battery pack was opened can be read out from the BCU. This information enables the supplier to establish whether the warranty claims are justified.

Since it is possible that the BCU is in the idle mode at the point in time when the battery pack is opened by someone, it is provided in a preferred embodiment that a wake-up signal is transmitted as the battery pack is opened.

The invention is not limited in its embodiment to the aforementioned preferred exemplary embodiments. On the contrary, a number of variants are feasible that make use of the arrangement in accordance with the invention, the battery in accordance with the invention and the motor vehicle in accordance with the invention even in the case of fundamentally different embodiments.

1. An arrangement, comprising:
at least one electrochemical cell; and
a housing configured to contain the at least one electrochemical cell,
wherein the housing includes a lock,
wherein the arrangement is configured such that in when the lock is activated, it is not possible to remove one or several electrochemical cells of the at least one electrochemical cell from the housing nor is it possible to remove said one or several electrochemical cells from the housing without the incident being registered.

2. The arrangement as claimed in claim 1, wherein authentication is required to unlock the lock.

3. The arrangement as claimed in claim 1, further comprising a mechanism configured for data entry and a mechanism configured to evaluate the entered data.

4. The arrangement as claimed in claims 2, further comprising a mechanism configured for authentication purposes in a dialogue form.

5. The arrangement as claimed in claim 2, wherein:
the arrangement is configured such that the housing can be opened, once authentication has been provided, and
the arrangement is configured such that the housing can be opened without authentication.

6. The arrangement as claimed in claim 2, wherein any incident of the housing being opened is monitored.

7. The arrangement as claimed in claim 6, further comprising:
a battery control unit configured to support or achieve at least the authentication and/or the monitoring of any incident of the housing being opened.

8. The arrangement as claimed in claim 1, wherein the lock is a magnetic lock.

9. A battery having a housing, the battery comprising:
at least one electrochemical cell,
wherein the housing includes a lock, and
wherein the housing is configured such that when the lock is activated, it is not possible to remove one or several electrochemical cells of the at least one electrochemical cell from the housing nor is it possible to remove said one or several electrochemical cells from the housing without the incident being registered.

10. A vehicle, comprising: an electric drive motor configured to drive the vehicle; and
a battery connected to or connectable to the electric drive motor, the battery including:
at least one electrochemical cell, and
a housing having a lock,
wherein the housing is configured such that when the lock is activated, it is not possible to remove one or several electrochemical cells of the at least one electrochemical cell from the housing nor is it possible to remove said one or several electrochemical cells from the housing without the incident being registered.
